(19) United States
(12) Patent Application Publication
(10) Pub. No.: US 2008/0306930 A1
(43) Pub. Date: Dec. 11, 2008

(54) Automatic Content Organization Based On Content Item Association

(75) Inventors: Elmo Marcus Attila Diederiks, Eindhoven (NL); Bartel Marinus Van de Sluis, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: PACE MICRO TECHNOLOGY PLC., West Yorkshire (GB)

(21) Appl. No.: 11/719,993

(22) PCT Filed: Nov. 30, 2005
(86) PCT No.: PCT/IB2005/053988

§ 371 Date: Mar. 3, 2008

Related U.S. Application Data
(60) Provisional application No. 60/632,134, filed on Dec. 1, 2004.

(51) Int. Cl. G06F 17/30

(52) U.S. Cl. 707/5; 707/102; 707/E17.022; 707/E17.071

(57) ABSTRACT

An association engine for organizing content items in a logical database is provided. First description data including dimension data for a first identified content item in the database is extracted (S1). This process may be repeated for additional available identified content items (S3). Candidate description data is extracted (S5). Then, a set of vector values for each candidate content item may be generated (S11), each vector value representing a degree of similarity between the dimension data for a dimension, for example, metadata, usage history, genre, content type, of the first description data and the corresponding dimension data of the candidate description data. A similar candidate content item from the candidate content items may be selected (S15) based on the degrees of similarity represented by the generated set of vector values, and grouped (S16) with the first content item in the organization of the logical database.

The present invention relates to the field of database content organization and management, and to content item association and grouping.

The storage capacity of storage devices and databases, including hard drives on personal computers and on other types of storage media has been rapidly increasing in recent years. It has been estimated that storage capacity doubles approximately every 12 months, while network bandwidth also has been increasing very rapidly. As a result, storage devices store a greater amount of content to which user access needs to be facilitated. A user can be overloaded with content stored on a storage device or database, unless the content is somehow managed or organized to provide convenient access for the user. On the other hand, content that is not grouped in a manner transparent to the user may be “lost” as far the needs of the user are concerned.

Various schemes for storage device organization exist. Lawler, U.S. Pat. No. 5,905,981 discloses associating with current news articles the content of a media object archive that includes an index having keywords for each media object. Obrador, International Publication No. WO 2004/012105 discloses selecting media objects from a collection of the media objects, based on relevance to one or more data structures selected from indexed, temporarily ordered data structures. However, each of these systems requires some sort of indexing, pre-existing ordering, and/or keywords.

It is also possible of course for a user to organize manually the content items of the storage device or database so that a satisfactory grouping of content items can be achieved. However this can be a time-consuming and onerous job. Further, as content items continue to accumulate in the storage device or database, continual intervention on the part of the user would be required to maintain convenient and logical grouping of items in the database.

Provided are a method, system, device, engine, apparatus, and computer-readable media that embodies or carries out the functions of an association engine for organizing content items in a logical database. This may be accomplished as follows. First description data including dimension data for a first identified content item in the logical database may be extracted. This process may be repeated for additional available identified content items. Candidate description data including corresponding dimension data for candidate content items in the logical database may further be extracted. Then, a set of vector values for each candidate content item may be generated, each vector value representing a degree of similarity between the dimension data for a dimension of the first description data and the corresponding dimension data of the candidate description data. A similar candidate content item from the candidate content items may be selected based on the degrees of similarity represented by the generated set of vector values. Accordingly, the similar candidate content item could be grouped with the first content item in the organization of the logical database.

Further, a dimension of the dimension data may represent a content type of the item, a content style for the item, a genre of the item, item metadata, usage history of the item, a performer performing in the item, a director associated with the item, a creator associated with the item, or the rendering requirements for the item. It will be understood that the metadata could represent a time of creation of the item, a place of creation of the item, a time of acquisition of the item, and/or a place of acquisition of the item.

The similar candidate content item may be selected only if a total degree of similarity represented by the set of vector values surpasses a minimum threshold. Such a threshold may be determined by the user or pre-set, or may be provided by the association engine depending on the results found. Also, when set by the user, the user may be prompted with a default threshold.

Further, the candidate content item or items with the highest total degree of similarity as represented by the set of vector values may be selected.

If additional identified content items are available, then description data including the dimensions data for a second identified content item grouped with the first identified content item may be extracted. Then, the similar candidate content item may be selected based also on a second set of vector values representing degrees of similarity between the dimension data for the second identified content item and the dimension data of the similar candidate content item. In such a case, the similar candidate content item may be selected such that the first set of vector values and the second set of vector values is averaged, weighted averaged, or added.

Also, a commonality vector, a vector that represents a dimension for which dimension data of the first identified content item is closest to the second identified content item, may be selected, and accordingly, in selecting the similar candidate content item weighting a value of the commonality vector more than remaining vector values.

Also disclosed is a virtual item generation based grouping. First description data including dimension data for a first identified content item in the logical database are extracted. Second description data including dimension data for a second identified content item in the logical database are also extracted. Candidate description data including corresponding dimension data for candidate content items in the logical database are then extracted. A virtual item may be constructed by averaging, weighted averaging or merely summing a virtual item set of vector values, in which each vector value represents a degree of similarity between a dimension of the dimension data of the first description data and a corresponding dimension of the dimension data of the second description data. A set of vector values for each candidate content item is generated, each vector value representing a degree of similarity between the dimension data for a dimension of the virtual content item and the corresponding dimension of the candidate content item's corresponding dimension data. Then, a similar candidate content item is selected from the candidate content items by computing as a testing value an average, a weighted average, and/or a sum for each set of vector values of the candidate content items, and determining as the similar candidate content item the candidate content item whose testing value surpasses a threshold. The similar candidate content item are grouped with the first content item in the organization of the logical database.

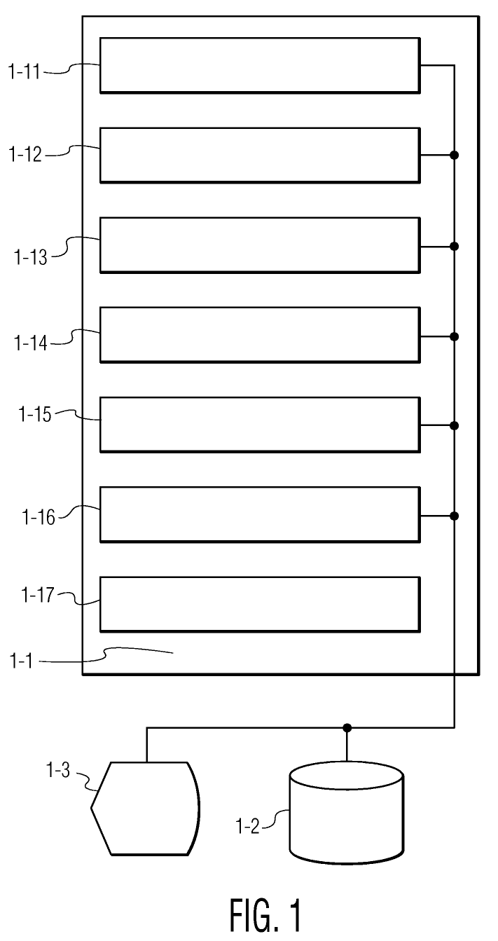

FIG. 1 is a schematic view all of an association engine according to an embodiment of the present invention.

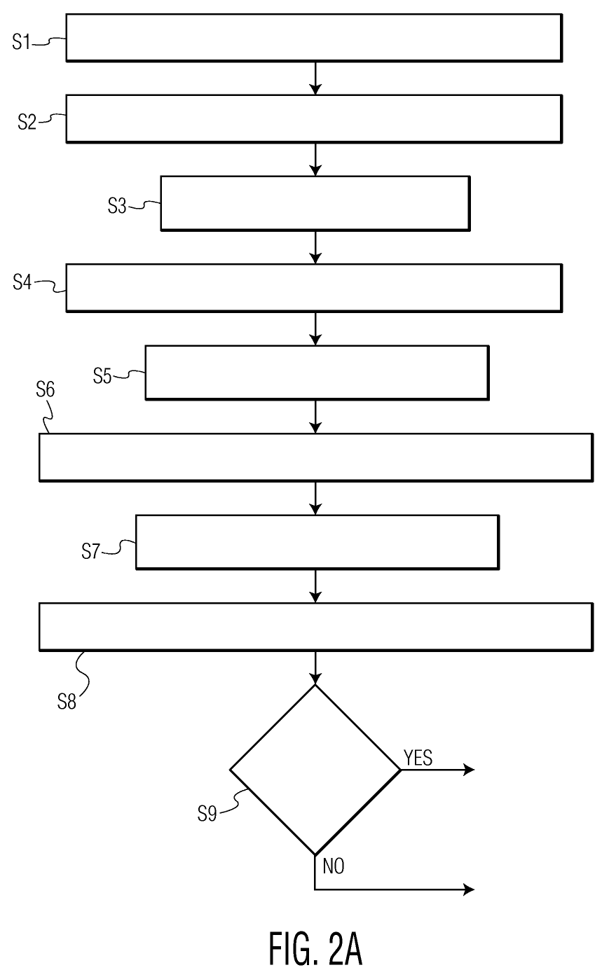

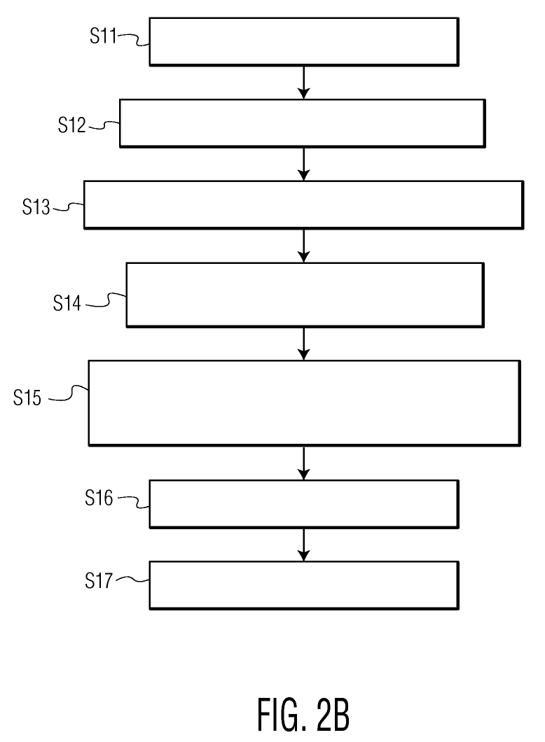

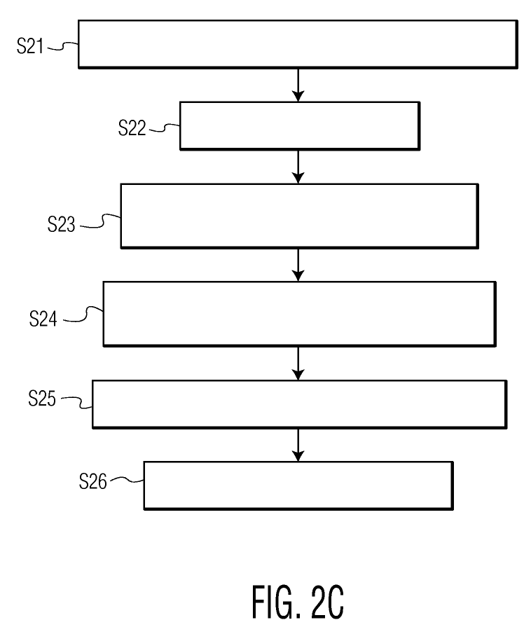

FIGS. 2A-2C are flowcharts operations of a system according to the present invention.

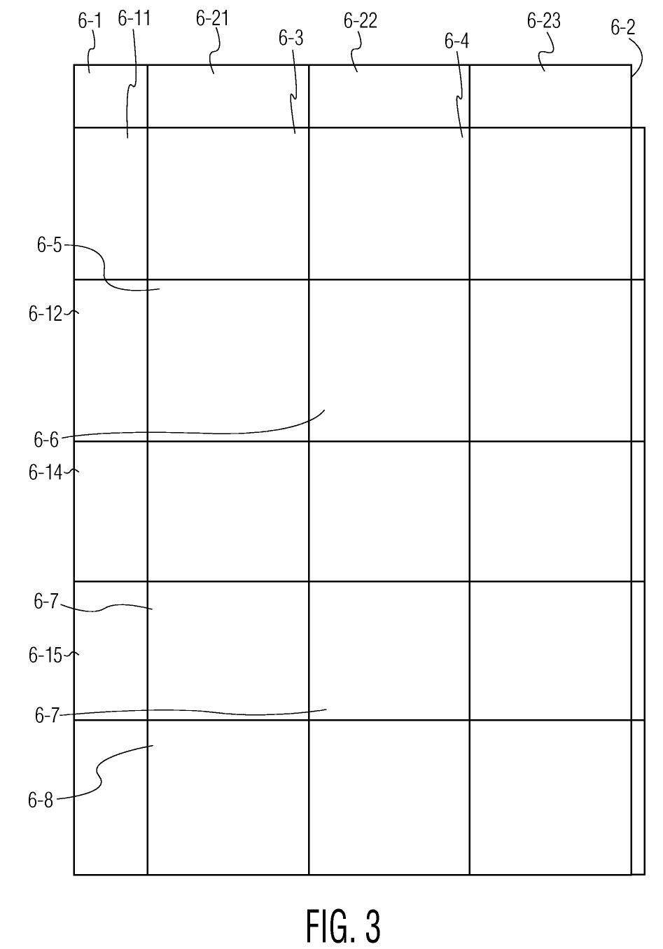

FIG. 3 shows a data chart of vector value alignment according to an embodiment of the present invention.

The following discussion and the foregoing figures describe embodiments of Applicant's invention as best understood presently by the inventors however, it will be appreciated that numerous modifications of the invention are possible and that the invention may be embodied in other forms and practiced in other ways without departing from the spirit of the invention. Further, features of embodiments described may be omitted, combined selectively or as a whole with other embodiments, or used to replace features of other embodiments, or parts thereof, without departing from the spirit of the invention. The figures and the detailed description are therefore to be considered as an illustrative explanation of aspects of the invention, but should not be construed to limit the scope of the invention.

As shown in FIG. 1, the association engine 1-1 includes several modules, which will be described below. Modules of the association engine 1-1, or portions thereof, and/or the association engine as a whole, may be comprised of hardware, software, firmware, or a combination of the foregoing, however some modules may be comprised of hardware for example, while other modules may be comprised of software, firmware or a combination thereof.

It is to be understood that modules of the association engine need not all be located or integrated with the same device. A distributed architecture is also contemplated for the association engine, which may “piggy-back” off of suitable modules provided by existing devices.

The following description will refer to an association engine 1-1 that is physically integrated with or connected to a logical database 1-2 via a wired or wireless connection thereto. The logical database 1-2 may be embodied on a storage device such as on a hard drive of a personal computer, a personal video recorder, an entertainment system, an electronic organizer, a personal handheld device, a Jaz drive, or may be embodied as a commercial storage facility, such as a disk drive. It will be understood that the logical database 1-2 may include several storage devices that are connected, such that organization or grouping of content items on two or more of such devices is possible. It will further be understood that the logical database may be understood to include one or more storage media, such as disks, including CDs, DVDs, zip disks, floppy disks, data cartridges, or the like, which can be loaded onto and retrieved by the logical database 1-2. Further, the logical database may be remotely accessed, such as via a network or the internet.

As shown in FIG. 1, the association engine 1-1 includes a description data extractor 1-11, which is a module that collects certain types of data from a content item. The content item may be a video, or a video clip, a movie, a photo, a text file, music data, an audio file, or other type of multimedia data, a JPEG file, or XML data. For example, the video may be a home video shot on a digital video recorder, the movie may be commercially distributed film data, such as a film encoded as MPEG (including MPEG-2, MPEG-3, or the like), the photo may be a digital photograph data, or series of photographs or a photograph album. The text file may be a word processor produced file, a spreadsheet, or a computer code file. The music data may be an MP3 file or the like, and so forth.

The description data extracted by the description data extractor 1-11 includes information about the content item. Such description data describe the dimensions of the content item. Such dimensions may include:

the content type, including the medium, such as the video, audio, photo, text file, etc.;

the content style or genre, such as holiday movie, personal landscape photography, jazz music or the like;

metadata for the item, such as time and/or location of the creation of the item, time and/or place of acquisition of the item;

usage history of the item, such as the last/first/penultimate et cetera, time and/or location and/or context of playback and/or editing, time period of most usage (for example, 6-9 AM has been the time period in which the content item has been used most), place of last usage, and place of most usage (for example, the home, or the living room, has been the place in which the content item has been used most); (Sometimes this usage history is also known as metadata for the item) and an actor, director, creator, artist, performer, photographer or the like associated with the content item.

It will be understood that such description data about the item may be located and extracted in a variety of ways, including from the item, from an index or database management file, or from an outside source such as from the World Wide Web connected to the association engine 1-1 via a wired or a wireless connection to the Internet.

The identified content item may be identified in one of several ways. A user may designate the item as an anchor item around which other items in the collection are to be grouped. Thus, the user may select the item as an anchor around which to group other similar items found by the association and in 1-1 in the logical database 1-2. Alternatively, a content item newly added or created may automatically be designated as an identified content item based on which other items in the logical database are to be grouped. Further, the system may identify isolated or ungrouped content items as identified content items and attempt to select content items for grouping therewith.

Based on these compiled dimensions of the description data extracted by description data extractor 1-11, similar item selector 1-12 identifies candidate content items in the logical database that are similar with respect to these dimensions of their description data to the first identified content item. Vector constructor 1-13 then creates a first set of vector values by assigning vector values to each of a number of vector as follows: each vector corresponds to a dimension, and a value for the vector reflects a degree of similarity or matching of a dimension of the first identified content item with the candidate content item.

For example, a vector that corresponds to the dimension of the content item termed style or genre would get a high value if both the identified content item and the candidate content item are of the same genre, such as “Spanish holiday.” A vector value of 1 or 0 may indicate little or no correlation or matching for the particular dimension between the first identified content item and the candidate content item, while a vector value of 9 or 10 may indicate a high degree of similarity or match. For example, when both content items have a genre of “Spanish holiday” then for the vector corresponding to the genre dimension, a 9 or 10 value would be assigned. Alternatively, instead of using a scale of 1 to 10, vector values may merely represent a “strong”, “normal”, or “weak” match for the dimension. It will be understood that numerous other schemes for such vector values may be used without departing from the spirit of the present invention. An average or a sum of such a set of vector values for a pair of content items would then be calculated as an overall degree of similarity between the two content items.

If a second identified content item is available, than a second set of vector values may be similarly constructed by vector constructor 1-13 based on description date extracted by description data extractor 1-11 for the second content item, such that this second set represents a degree of similarity between corresponding dimensions of this second identified content item and a candidate content item. There may be additional available identified content items. Thus, this process of description data extraction and vector value set generation may be repeated for any number of available identified content items 1-N, N being a positive integer greater than 1. Then, the candidate content item selection is performed based on all such generated vector value sets, or their average.

If more than one identified content items are available, then a commonality vector generator/threshold setter 1-14 may select one or more vectors for which the vector values of the first set and the second set are consistently high. Such vector values may then be weighted more than values for the other vectors in the average or sum of the set of vector values representing the overall degree of similarity between the two items. In this way, a dimension which is representative of the first and second identified content item, or which tends to capture the similarity between the first and second identified content item and is therefore characteristic of the group being formed (based on content items already in the group) would be weighted more then other vector values. Although shown as part of a single module 1-14, separate modules, a commonality vector generator module and a threshold setter module may be constructed as part of the association engine 1-1, or such modules may be incorporated into other modules.

Virtual item constructor 1-15 will be described below in the context of a discussion of an operation of an embodiment of the present invention.

Controller 1-16 handles other tasks necessary for the operation of the association engine, such as interfacing with other devices and communication with the outside, including interfacing with a user (not shown). Controller 1-16 also handles overall control and coordination of the modules of the association engine 1-1.

Group organizer 1-17 provides grouping signals to the logical database 1-2 based on the vector values obtained a body association engine 1-1. User interface 1-3 may be a separate device or may be integrated with another device or system, such as a personal computer or a personal video recorder, or one or more of the storage and other devices enumerated above.

An operation of an embodiment of the present invention will now be described with reference to FIGS. 1-3. A first content item is identified, as described above, by a user via user interface 1-3 shown in FIG. 1, or automatically by the system, for example by a detection of a newly added content item or an isolated content item in logical database 1-2.

Description data extractor 1-11 of association engine 1-1 extracts first description data for the first content item identified, as stated at S1 of FIG. 2A. FIG. 3 shows a box labeled 6-11 referencing identified content item 1. At S2, dimension data for each of the dimensions for the first identified content item are compiled. It will be understood, that depending on the database or storage device and the types of content items to be grouped or organized, some or all of the above-identified dimensions may be more relevant, while others may be completely irrelevant and unused by an association engine according to the present invention. Also other dimensions not explicitly recited here may be particularly relevant and used by the association engine 1-1.

If an additional second identified content item, shown in FIG. 3 as 6-12, is available or has been identified, then steps S3 and S4 are performed: at S3 description data for the identified content item is extracted, and at S4, dimension data for each of the dimensions for the second identified content item are compiled. As shown in FIG. 3, a number of content items may be identified as anchor content items around which grouping of other content items is desired. FIG. 3 shows a table 6-1 with first identified content item, 6-11, second identified content item, 6-12, and identified content item N, 6-14. Therefore, this process would be repeated for each of the first-N identified content items.

Similar content item selector 1-12 of FIG. 1 identifies candidate content items in the logical database 1-2, while description data extractor 1-11 at S5 (FIG. 2A) extracts description data for each of the candidate content items and, at S6, compiles the dimension data for each of the content items. The process of extracting the corresponding description data of a second candidate content item (represented in box 6-22), if found, is performed at S7, and the compilation of the dimension data for the second candidate content item is then performed at S8.

According to an aspect of the present invention, At S9, depending on the system settings or depending on the user's setting or current command, it may be decided that a virtual item is to be constructed as a basis for determining the similarity of candidate content items, in which case processing will proceed as shown in FIG. 2C. Otherwise, processing would proceed as shown in FIG. 2B.

Based on the similarity or match of each dimension of each identified content item with the corresponding dimension of each candidate content item, a vector value is constructed by a vector constructor 1-13 as shown in S11 of FIG. 2B. FIG. 3 shows 6-3 a set of vectors with values that reflect the degree of similarity for corresponding dimensions of first identified content item 6-11 with the first candidate content item 6-21. Similarly, a set of vector values 6-4 reflects the similarity of the dimensions of first identified content item, 6-11, with second candidate content item, 6-22. With respect to second identified content item, 6-12, the set of vector values 6-5 reflects the degrees of similarity for corresponding dimensions with first candidate content item 6-21, while the set of vector values 6-6 reflects the degree of similarity between dimensions of second identified content item, 6-12, with candidate content item 6-22.

Each set of vector values also may include an average vector value determined at S12, based on computation of the average of the vector values of this set, that reflects the average similarity for the pair of content items. The term average as used throughout herein may include one or more of arithmetic mean, mode, median, sum, or some other similar statistical function. Thus, for instance, vector values 6-3 of FIG. 3, may include a first vector value, a second vector value, and h-th vector value, and an average value for the set.

Further identified content items may also be available, and the process of extracting the dimension data and finding a set of vector values based on the similarity with corresponding dimensions of candidate content items would continue. Box 1-14 of FIG. 3 shows identified content item M.

Also, further candidate content items may be found, and for each one, sets of vector values could be calculated for each identified content item. Box 6-23 references such a candidate content item M.

According to an embodiment of the present invention, at S13, a commonality vector value set is determined based on the similarity of dimensions between identified content items. Thus, dimensions that are most similar are identified, and representative vectors can be weighted more than the other vectors, or can be used exclusively. In this way, a dimension which is representative of the first and second (and additional) identified content items, and which therefore tends to capture the similarity between the identified content items and is therefore characteristic of the group being formed would be weighted more then other vector values, or would be used exclusively to determine similar candidate content items.

At S14, a further set of vector values 6-8 may be computed that reflect the overall similarity for each of the dimensions for each candidate content item, by averaging or adding corresponding vector values of the candidate content item 6-21. Thus, for instance by adding or averaging corresponding vector values for each set of vector values for that candidate content item, an overall degree of similarity with the identified content items for the dimension is attained for the first candidate content item. Further, all of the vector values of the set 6-8 may be added or averaged to obtain an total similarity value for that candidate content item.

It will be understood, that average as used herein may include an arithmetic mean, a mode, a median or some such other statistical function suitably selected to provide a composite view of the selected values. Further, a simple sum of the values may be used as well as some such statistical function. Depending on the type of content item, and depending on the database and the needs of the user, certain dimensions all of the content item may be more important than others, and for this reason it may be helpful to weight vectors corresponding to certain dimensions more than others. The degree to which such factors are weighted would depend on the application and the needs of the user.

Once the vector values of the overall similarity set 6-8 are generated, a minimal similarity threshold may be used to eliminate non-similar candidate content items, as shown at S15 of FIG. 2B.

Further, it is also contemplated that different thresholds may be employed for the various vectors, depending on the needs of the user and the application. Accordingly, candidate content items for which the vector values meet or surpass the threshold value are grouped with the identified content items by group organizer 1-17, while other candidate content items are rejected. Alternatively, the most similar candidate content item, or predetermined number of the most similar candidate content items may be selected for grouping with the identified content items, while the remainder of the candidate content items may be rejected.

This (or these) selected candidate content item(s) are grouped with the identified content items at S16. The grouping signal may be provided directly to the database 1-2 to cause grouping or regrouping of the selected similar candidate content items with the identified content items, or may be provided to user interface 1-3 to notify a user (not shown) of a recommended grouping or regrouping. A notification to the user may also be provided, consisting of an identification of the similar content item, a description of the similar content item, a URL or a link to the similar content item, or a display or playback of the entire similar content item or a portion thereof, or a combination of the foregoing. At S17, processing terminates.

FIG. 2C shows a process using a virtual content item according to an aspect of the present invention. At S21, virtual item constructor 1-15 analyzes the dimensions of the identified content items based on which a grouping is sought. At S22, a representative content item for all of the identified content items, called a virtual content item 6-15 is then constructed based on the average or weighted average dimensions of the identified content items. For example, if all of the identified content items are of the genre “Spanish holiday,” then the virtual content item would also have as its genre “Spanish holiday.” Then, at S23 vector values 6-7 are generated based on the similarity of the dimensions of this virtual content item with the candidate content items. At S24, the threshold is applied in selecting similar candidate content items are selected, or the highest scoring candidate content item or items are selected.

Based on the candidate content items selected as similar using thresholding, or based on the predetermined number of the most similar candidate content items that are selected, at S25, a grouping signal is transmitted in a wired or wireless manner by 1-17 of the association engine 1-1 shown in FIG. 1. As discussed, the signal may be provided directly to the database 1-2 to cause grouping or regrouping of the selected similar candidate content items with the identified content items, or may be provided to user interface 1-3 to notify a user (not shown) of a recommended grouping or regrouping. At S26, processing terminates.

For example, suppose a user is compiling digital data representing photographs of a recent holiday in Spain in a logical database and would like to find other content items with a Spanish theme available in the database, in another connected storage medium, or available over the internet. The user may select the three photos as identified content item 1, identified content item 2, and identified content item 3, respectively, via user interface 1-3. The association engine would then group a data file representing Spanish music found as similar candidate content item with the identified content items 1-3. The user may not have remembered the existence of the Spanish music, or where to look for it, and indeed the data file may have been added by another user with access to the logical database 1-2 or may have been retrieved by the association engine 1-1 from another storage device. In any event, the user would now be notified of the similar content item and/or the similar content item would be grouped with the identified content items. The user would then be able to accompany the viewing of the Spanish holiday photographs with Spanish music.

Embodiments of the present invention provided in the foregoing written description are intended merely as illustrative examples. It will be understood however, that the scope of the invention is provided in the claims.

1. A method of organizing content items in a logical database, the method comprising:
extracting (S1) first description data including dimension data for a first identified content item in the logical database;
extracting (S5) candidate description data including corresponding dimension data for candidate content items in the logical database;
generating (S11) a first set of vector values for each candidate content item, each vector value representing a degree of similarity between the dimension data for a dimension of the first description data and the corresponding dimension data of the candidate description data;
selecting (S15) a similar candidate content item from the candidate content items based on the degrees of similarity represented by the generated first set of vector values; and
grouping (s16) the similar candidate content item with the first content item in the organization of the logical database.

2. The method of claim 1, wherein a dimension of the dimension data represents one of a content type of the item, a content style for the item, a genre of the item, usage history of the item, a performer performing in the item, a director associated with the item, a creator associated with the item, rendering requirements for the item, and any metadata for the item.

3. The method of claim 2, wherein the metadata represents one of a time of creation of the item, a place of creation of the item, a time of acquisition of the item, a place of acquisition of the item, a time of last usage, a time period of most usage, a place of last usage, and a place of most usage.

4. The method of claim 1, wherein the similar candidate content item is selected only if a total degree of similarity represented by the first set of vector values surpasses a minimum threshold.

5. The method of claim 1, wherein the candidate content item with the highest total degree of similarity as represented by the first set of vector values is selected.

6. The method of claim 1, further comprising:
extracting (S3) description data including the dimension data for an N-th identified content item grouped with the first identified content item, N being any positive integer greater than 1; and
automatically selecting (S15) the similar candidate content item based also on an N-th set of vector values representing degrees of similarity between the dimension data for the N-th identified content item and the dimension data of the similar candidate content item.

7. The method of claim 6, wherein the similar candidate content item is selected such that the first set of vector values and the N-th set of vector values is one of averaged, weighted averaged, and added.

8. The method of claim 6, comprising selecting, as a commonality vector, a vector that represents a dimension for which dimension data of the first identified content item is closest to the N-th identified content item, and in selecting the similar candidate content item weighting a value of the commonality vector more than remaining vector values of the first set of vector values and the N-th set of vector values.

9. A method of organizing content items in a logical database, the method comprising:
extracting (S1) first description data including dimension data for a first identified content item in the logical database;
extracting (S2) N-th description data including dimension data for a N-th identified content item in the logical database, N being any positive integer greater than 1;
extracting (S5) candidate description data including corresponding dimension data for candidate content items in the logical database;
constructing (S22) a virtual item by one of averaging and weighted averaging a virtual item set of vector values, each vector value of the virtual item set of vector values representing a degree of similarity between a dimension of the dimension data of the first description data and a corresponding dimension of the dimension data of the N-th description data;
generating (S23) a set of vector values for each candidate content item, each vector value representing a degree of similarity between the dimension data for a dimension of the virtual content item and corresponding dimension data for the candidate content item;
selecting (S24) a similar candidate content item from the candidate content items by computing as a testing value one of an average, a weighted average, and a sum for each set of vector values of the candidate content items, and determining as the similar candidate content item the candidate content item whose testing value surpasses a threshold; and
grouping (S24) the similar candidate content item with the first content item in the organization of the logical database.

10. A system of organizing content items in a logical database, the system comprising:
a description data extractor (1-11) configured to extract first description data including dimension data for a first identified content item in the logical database;
said description data extractor further configured to extract candidate description data including corresponding dimension data for candidate content items in the logical database;
a vector constructor (1-13) configured to generate a first set of vector values for each candidate content item, each vector value representing a degree of similarity between the dimension data for a dimension of the first description data and the corresponding dimension data of the candidate description data;
a commonality vector generator/threshold setter (1-14) configured to select a similar candidate content item from the candidate content items based on the degrees of similarity represented by the generated first set of vector values; and
a group organizer (1-17) configured to group the similar candidate content item with the first content item in the organization of the logical database.

11. The system of claim 10, wherein a dimension of the dimension data represents one of a content type of the item, a content style for the item, a genre of the item, usage history of the item, a performer performing in the item, a director associated with the item, a creator associated with the item, rendering requirements for the item, and any metadata for the item.

12. The system of claim 11, wherein the metadata represents one of a time of creation of the item, a place of creation of the item, a time of acquisition of the item, a place of acquisition of the item, a time of last usage, a time period of most usage, a place of last usage, and a place of most usage.

13. The system of claim 10, wherein said commonality vector generator/threshold setter is configured to select the similar candidate content item only if a total degree of similarity represented by the first set of vector values surpasses a minimum threshold.

14. The system of claim 10, wherein said commonality vector generator/threshold setter is further configured to select as the similar candidate content item the candidate content item with the highest total degree of similarity as represented by the first set of vector values.

15. The system of claim 10, wherein said description data extractor is further configured to extract description data including the dimension data for a N-th identified content item grouped with the first identified content item, N being any positive integer greater than 1, and
said commonality vector generator/threshold setter is configured to automatically select the similar candidate content item based also on a N-th set of vector values representing degrees of similarity between the dimension data for the N-th identified content item and the dimension data of the similar candidate content item.

16. The system of claim 15, wherein said commonality vector generator/threshold setter is configured to select the similar candidate content item such that the first set of vector values and the N-th set of vector values is one of averaged, weighted averaged, and added.

17. The system of claim 15, wherein said commonality vector generator/threshold setter is configured to select, as a commonality vector, a vector that represents a dimension for which dimension data of the first identified content item is closest to the N-th identified content item, and in selecting the similar candidate content item weighting a value of the commonality vector more than remaining vector values of the first set of vector values and the N-th set of vector values.
